(19) United States
(12) Patent Application Publication
(10) Pub. No.: US 2023/0159158 A1
(43) Pub. Date: May 25, 2023

(54) AIRCRAFT LANDING GEAR BAY DOOR

(71) Applicants: AIRBUS OPERATIONS LIMITED, Bristol (GB); AIRBUS OPERATIONS GMBH, Hamburg (DE); AIRBUS OPERATIONS (S.A.S.), Toulouse (FR)

(72) Inventors: Aline SCOTTO, Toulouse (FR); Maxime ITASSE, Toulouse (FR); Alexander BÜSCHER, Hamburg (DE); Christopher PERKINS, Bristol (GB); Alan MANN, Bristol (GB); Kevin IP, Bristol (GB); Neil LYONS, Bristol (GB); Robert MILLS, Bristol (GB)

(21) Appl. No.: 17/992,731

(22) Filed: Nov. 22, 2022

(30) Foreign Application Priority Data
Nov. 25, 2021 (FR) 2112528

(51) Int. Cl. B64C 25/16; B64C 25/20; B64C 25/36; G10K 11/16

(52) U.S. Cl. CPC B64C 25/16; B64C 25/20; B64C 25/36; G10K 11/161

(57) ABSTRACT

An aircraft landing gear bay door 140 including an attachment mechanism suitable for pivotally mounting the door to an aircraft, a first side 141 arranged to face inwardly in relation to the aircraft landing gear bay when the door is closed and face towards one side of a main leg of the landing gear when the door is open and the landing gear is deployed, and a second opposite side 142. The shape formed from the first and second sides provides an aerofoil profile of the door. The invention also provides an aircraft landing gear arrangement 100, an aircraft 1000, methods of operating an aircraft and a method of reducing noise.

### RELATED APPLICATION

This application incorporates by reference and claims priority to French patent application FR 2112528, filed Nov. 25, 2021.

### FIELD

The present disclosure relates to an aircraft landing gear bay door. The present invention concerns aircraft landing gear bay doors.

### BACKGROUND

There are many different landing gear bay door arrangements, often comprising doors used to open and close the landing gear bay to allow a landing gear to deploy from the bay. These doors are often generally planar (see U.S. Pat. No. 8,708,272, for example) and may be designed to have an external side that is contoured to match the surrounding contour of the aircraft where it is located. This is done to maintain the aerodynamic profile of the part of the aircraft where the door is located, when the door is closed. The aerodynamic profile will typically be shaped so as to reduce the drag of the aircraft when the landing gear bay doors are closed.

However, such landing gear bay doors are not designed or adapted for noise reduction purposes. In particular, there is no consideration of noise reduction when the doors are open and the landing gear is deployed, for example on landing approach. Here, it is important to reduce the noise footprint of the aircraft. This is different to wishing to reduce the drag, as that is not a concern when the aircraft is landing and slowing down anyway.

The present invention seeks to mitigate one or more of the above-mentioned problems. Alternatively or additionally, the present invention seeks to provide an improved aircraft landing gear bay door.

The project leading to this application has received funding from the European Union's Horizon 2020 research and innovation programme under grant agreement No 769350.

### SUMMARY

The invention described here concerns an aircraft landing gear bay door comprising an attachment mechanism suitable for pivotally mounting the door to an aircraft such that the door can move between a closed position, in which the door at least partially closes an aircraft landing gear bay to stow a landing gear therein, and an open position, in which the door at least partially opens the landing gear bay to allow the landing gear to deploy, and a first side arranged to face inwardly in relation to the aircraft landing gear bay when the door is closed and face towards one side of a main leg of the landing gear when the door is open and the landing gear is deployed, a second opposite side arrange to face outwardly in relation to the landing gear bay when the door is closed and thus provide an aerodynamic outer surface of the aircraft, and face away from the main leg of the landing gear when the door is open and the landing gear is deployed.

The invention also concerns an aircraft landing gear arrangement, an aircraft, methods of operating an aircraft and a method of reducing noise.

The invention provides, according to a first aspect, an aircraft landing gear bay door comprising an attachment mechanism suitable for pivotally mounting the door to an aircraft such that the door can move between a closed position, in which the door at least partially closes an aircraft landing gear bay to stow a landing gear therein, and an open position, in which the door at least partially opens the landing gear bay to allow the landing gear to deploy, and a first side arranged to face inwardly in relation to the aircraft landing gear bay when the door is closed and face towards one side of a main leg of the landing gear when the door is open and the landing gear is deployed, a second opposite side arrange to face outwardly in relation to the landing gear bay when the door is closed and thus provide an aerodynamic outer surface of the aircraft, and face away from the main leg of the landing gear when the door is open and the landing gear is deployed, wherein the shape formed from the first and second sides provides an aerofoil profile of the door.

Such a door with the aerofoil profile acts to slow down the airflow flowing past the inner side. This reduces the noise of the airflow flowing past the landing gear. Hence, it means that the aircraft using such a door will have a lower noise footprint, especially when the landing gear is deployed and the aircraft is coming into land.

Throughout the specification, the terms fore/aft, forward/backward, behind/in front, height, side etc. should be construed in relation to the conventional terms for an aircraft during normal flight. For example, upstream corresponds to a forward/fore region and downstream corresponds to a backward/aft region. Hence, if the first side directly faces the one side of a main leg of the landing gear, it will be directly facing laterally (starboard or port-wards) and so at 90 degrees to the aircraft longitudinal axis. Hence, the door itself will be roughly aligned with the direction of the aircraft longitudinal axis, when open. Height corresponds to the dimension in the upward/vertical (z) direction, in relation to a level orientation of the aircraft with respect to the ground.

The attachment mechanism may attach the door to the aircraft directly. For example, the door may be pivotally mounted adjacent to a landing gear bay of an aircraft. However, the attachment mechanism may also attach the door to a deployable landing gear leg so that the door can pivot with respect to the aircraft as the leg is deployed.

The door may be roughly aligned with (i.e., substantially in) the direction of the aircraft longitudinal axis, when open. A pivotal axis of the door relative to the aircraft may be substantially aligned with the direction of the aircraft longitudinal axis. For example, a plane containing the door (i.e., a plane enclosing the door thickness/smallest dimension) is orientated in a fore-aft direction of the aircraft, when open. For example, it may be that the door is substantially parallel to a longitudinal axis of the aircraft.

The landing gear door may be one of several landing gear doors working in combination to close and open the landing gear bay.

The first side may be contained within the landing gear bay when the door is closed. For example, it may be that only a second opposite side of the door may provide an aerodynamic surface of the aircraft when the door is closed.

Thus in certain embodiments, the second side of the door, at least when the door is deployed, may be contoured to deviate from the shape that would be defined, with the door in its closed position, by a continuance of the surrounding exterior (largely planar) contour of the aircraft (e.g. the fuselage or the landing gear fairing).

The first side may provide one half of an aerofoil profile and wherein the second side provides a corresponding other half of an aerofoil profile. In embodiments, it may be that the inner side of the door has a profile that matches one half of an aerofoil profile. For example, a lower half of an aerofoil profile. The aerofoil profile may run along a longitudinal direction of the door, in use. The outer side of the door has a profile that matches one half of an aerofoil profile. For example, both inner and outer sides of the door may provide respective halves of an aerofoil profile. For example, the half provided by the outer side may be the opposite half to the inner side of the door, for example an upper half of an aerofoil profile. The aerofoil profile may run along a longitudinal direction of the door, in use. The leading edge of the complete aerofoil profile may be located at an upstream edge of the door, when open.

A leading edge of the aerofoil profile may be located at an upstream edge of the door, when open.

The aerofoil profile may have a height corresponding to at least 80%, or at least 90%, of the height of the door. Here, height refers to the vertical dimension when the door is open.

The aerofoil profile may have a camber. The camber may move inwards or outwards from leading edge to trailing edge of the aerofoil profile. The leading edge may be nearer or further away from the landing gear leg, than the trailing edge in the lateral dimension. For example, the trailing edge may partly curve around the landing gear leg, in use, wherein the trailing edge of the aerofoil profile is straight. For example, in embodiments, it may be that the aerofoil profile has an abrupt trailing edge of a certain thickness, rather than tapering to a point. Alternatively, the trailing edge of the aerofoil profile may be tapered.

A region of the aerofoil profile may be provided with a bulged portion, bulging towards the second side of the door. Such a curved bulged portion acts to significantly slow down airflow and hence, reduce noise. The bulged portion may be located towards a rear/trailing end of the aerofoil profile. For example, in embodiments, it may be more than halfway along the length of the aerofoil profile from the leading edge. The first side of the aerofoil profile may be provided with the bulged portion. For example, the first side at the bulged portion may be offset past the rest of the second side, wherein the second side of the aerofoil profile may also be provided with the bulged portion.

The shape of the door may be such that along a longitudinal section of the door when open, the thickness of the door is greater than a first thickness for at least a fifth of its length in the longitudinal direction and is less than a second (lower) thickness for at least a fifth of its length in the longitudinal direction. It may be that the first thickness is at least 25% greater than, or 50% greater than, for example twice as great as or more than twice as great as, the second thickness. The thickness of the door may be defined as the separation between the first side and the second side at the particular location along the longitudinal section. The longitudinal section may be taken at a mid-way point along the height of the door, when open.

The first thickness may be located upstream of the second thickness. In other words, the first (greater) thickness occurs nearer a leading edge of the door, than the second thickness. The thickness of the door may be greater than the first thickness for at least half of its length in the longitudinal direction and is less than the second thickness for at least a fifth of its length in the longitudinal direction. The thickness of the door may be greater than the first thickness for at least three fifths of its length in the longitudinal direction and is less than the second thickness for at least a fifth of its length in the longitudinal direction.

The door may comprise a moveable component, moveable from a first position when the door is closed to a second position when the door is open and wherein, in the second position, the moveable component moves to form the aerofoil profile. This movement may be automatic, for example due to abutment of the moveable component against a door closure frame, or other part of the aircraft in contact when the door is closed. The moveable component may be a memory shape component and wherein the memory shape component is biased to be in the second portion and is urged to the first position as the door closes. For example, due to abutment of the memory shape component against a door closure frame, or other part of the aircraft it contacts when the door is closed. The memory shape component may, for example, comprise a memory shape alloy or a memory shape composite material.

According to a second aspect of the invention there is also provided an aircraft landing gear arrangement including the aircraft landing gear bay door as described above and a landing gear including a main landing gear leg, the main landing gear leg being pivotally mountable in relation to an aircraft landing gear bay between a stowed and a deployed position, and comprising a number of landing gear wheels arranged to roll in a fore/aft direction when in the deployed position.

When the door is in the open position and the landing gear is in the deployed position, the aerofoil profile may at least be partially aligned with the landing gear leg in the fore/aft direction. For example, it may be that the landing gear leg and the aerofoil profile are at the same longitudinal position along the aircraft, in use. The landing gear leg may be aligned with a rear/trailing end of the aerofoil profile. For example, it may be aligned with the aerofoil profile more than halfway along the length of the aerofoil profile from the leading edge.

When the door is in the open position and the landing gear is in the deployed position, the bulged portion of the aerofoil profile may be at least partially aligned with the landing gear leg in the fore/aft direction.

When the door is in the open position and the landing gear is in the deployed position, the aerofoil profile may be offset from the landing gear leg in the lateral direction by an offset distance. In other words, the landing gear leg and the aerofoil profile are separated in the dimension across the aircraft, in use. The offset distance may be at least 20 mm, for example at least 30 mm, or at least 50 mm, or at least 100 mm. They may be offset by less than 5 times the width of the landing gear leg. They may be offset by less than 200 mm. The offset distance may, at least in part, be dictated by the flow velocity in the region and/or by the clearance requirements between the landing gear and the door.

According to a third aspect of the invention there is also provided an aircraft comprising the aircraft landing gear bay door or the aircraft landing gear arrangement as described above.

According to a fourth aspect of the invention there is also provided a method of operating an aircraft, including the step of using the aircraft landing gear bay door, the aircraft landing gear arrangement or aircraft as described above.

According to a fifth aspect of the invention there is also provided a method of operating an aircraft comprising the steps of opening a landing gear bay door, deploying a landing gear, including a main leg, and an aerofoil profile to the door causing the velocity of the air flow in between the side of the main leg of the landing gear and the landing gear bay door to be reduced.

According to a sixth aspect of the invention there is also provided a method of reducing noise generated by a landing gear on landing approach, comprising the steps of opening a landing gear bay door, deploying a landing gear, including a main leg, and an aerofoil profile to the door causing the velocity of the air flow in between the side of the main leg of the landing gear and the landing gear bay door to be reduced.

It will of course be appreciated that features described in relation to one aspect of the present invention may be incorporated into other aspects of the present invention. For example, the method of the invention may incorporate any of the features described with reference to the apparatus of the invention and vice versa.

### DESCRIPTION OF THE DRAWINGS

Embodiments of the present invention will now be described by way of example only with reference to the accompanying schematic drawings of which:

FIG. 1 shows a side view of a landing gear arrangement according to a first embodiment of the invention;

FIG. 2 shows a schematic plan view of the landing gear arrangement of FIG. 1;

FIG. 3 shows a schematic plan view of a landing gear arrangement according to second embodiment of the invention;

FIG. 4 shows a schematic plan view of a landing gear arrangement according to third embodiment of the invention;

FIG. 5 shows a schematic plan view of a landing gear arrangement according to fourth embodiment of the invention;

FIG. 6 shows a schematic plan view of a landing gear arrangement according to fifth embodiment of the invention;

FIG. 7 shows a schematic plan view of a landing gear arrangement according to sixth embodiment of the invention;

FIG. 8 shows a schematic plan view of a landing gear arrangement according to seventh embodiment of the invention;

FIG. 9 shows a schematic plan view of a landing gear arrangement according to eight embodiment of the invention;

FIG. 10 shows a schematic plan view of a landing gear arrangement according to ninth embodiment of the invention;

FIG. 11 shows a schematic plan view of a landing gear arrangement according to tenth embodiment of the invention;

FIG. 12 shows a schematic plan view of a landing gear arrangement according to eleventh embodiment of the invention;

FIG. 13 shows a schematic plan view of a landing gear arrangement according to twelfth embodiment of the invention;

FIG. 14 shows a schematic plan view of a landing gear arrangement according to thirteenth embodiment of the invention;

FIG. 15a shows a schematic upside down side view of a stowed and closed landing gear arrangement according to fourteenth embodiment of the invention;

FIG. 15b shows a schematic plan view of the landing gear arrangement of FIG. 15a, in an open and deployed configuration;

FIG. 15c shows a schematic plan view of the landing gear arrangement of FIG. 15a, in a second open and deployed configuration; and

FIG. 16 shows a schematic front view of an aircraft with a nose landing gear arrangement and two main landing gear arrangements, the landing gear arrangements being suitable for being in accordance with any of the embodiments of the invention.

### DETAILED DESCRIPTION

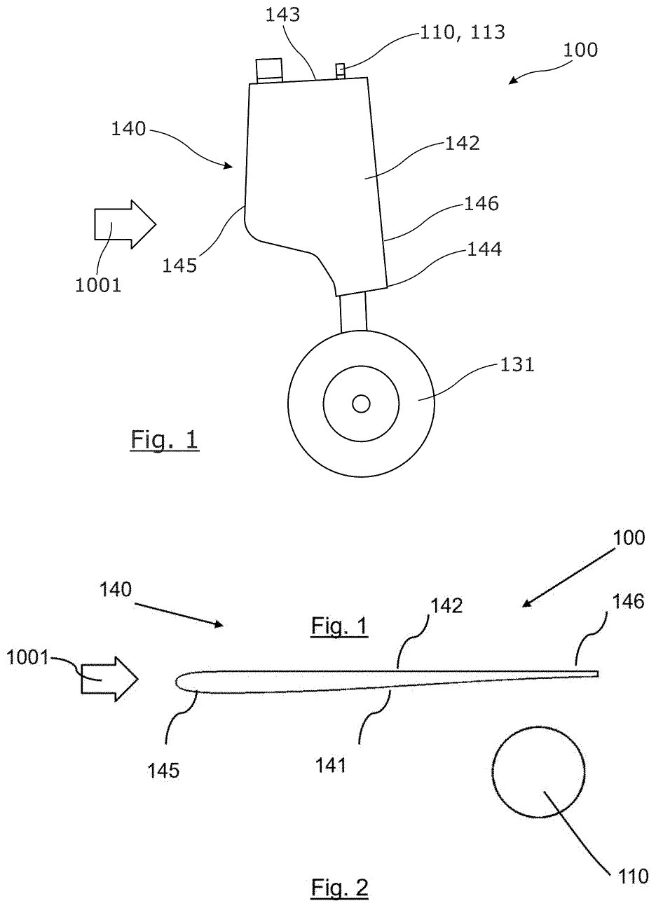

FIG. 1 shows a side view of a landing gear arrangement 100 according to a first embodiment of the invention. FIG. 2 shows a schematic plan view of the landing gear arrangement of FIG. 1.

The arrangement 100 comprises a landing gear main leg 110, which, in use, is pivotally connected to an aircraft by a pivot mechanism 113 at the top of the leg. At the bottom of the leg is an axle, which mounts two landing gear wheels, only one (labelled 131) seen in FIG. 1. The wheels roll in a fore/aft (or longitudinal) direction. A side stay (not seen) is pivotally mounted on the leg 110 and also to the aircraft, in use.

The landing gear main leg 110, side stay and axle/wheels are entirely conventional and comprise various other elements/features, such as oleo struts, support arms/braces, electrical installations, brake assemblies, actuators etc. which will not be described here.

The arrangement 100 also includes a landing gear bay door 140. The door 140 has an outer side 142 (facing away from the leg 110) and an inner side 141 (facing the leg 110). Slightly below the top edge 143 on the inner side 141 is an attachment mechanism to mount the door 140 to the leg 110.

The door 140 has a front edge 145 and a rear edge 146. The rear edge is the full door height but the front edge 145 is slightly shorter. It is the longest dimension, i.e., at the rear edge, that defines the door height. The front edge 145 is shorter as the bottom edge 144 of the door 140 is shaped to curve upwards towards the front edge 145.

The arrangement 100 is shown in relation to an oncoming airflow 1001.

As can be seen in FIG. 2, a unique feature of the door 140 is that the door 140 has a cross-sectional shape, in plan view, of that of an aerofoil. In other words, the front edge 145 has the shape of a rounded leading edge of an aerofoil and the shape tapers towards a trailing edge at the rear edge 146.

The aerofoil shape provided has a planar outer side 142. Hence, when the landing gear bay door 140 is closed in use, the planar outer side 142 forms an outside contour of the aircraft. It, in fact, provides a contour that matches/follows that of the surrounding generally planar contour of the aircraft. The aerofoil shape also has a straight edge at the rear edge 146 to provide a finite thickness at that edge 146.

The aerofoil shape provided has a curved concave inner side 141. Hence, when the landing gear bay door 40 is open airflow between the inner side 141 and the landing gear leg 110 is caused to slow down and thus reduce the noise generated.

The aerofoil profile shape is provided on the door along its entire height/length (i.e., from the top 143 to the bottom 144).

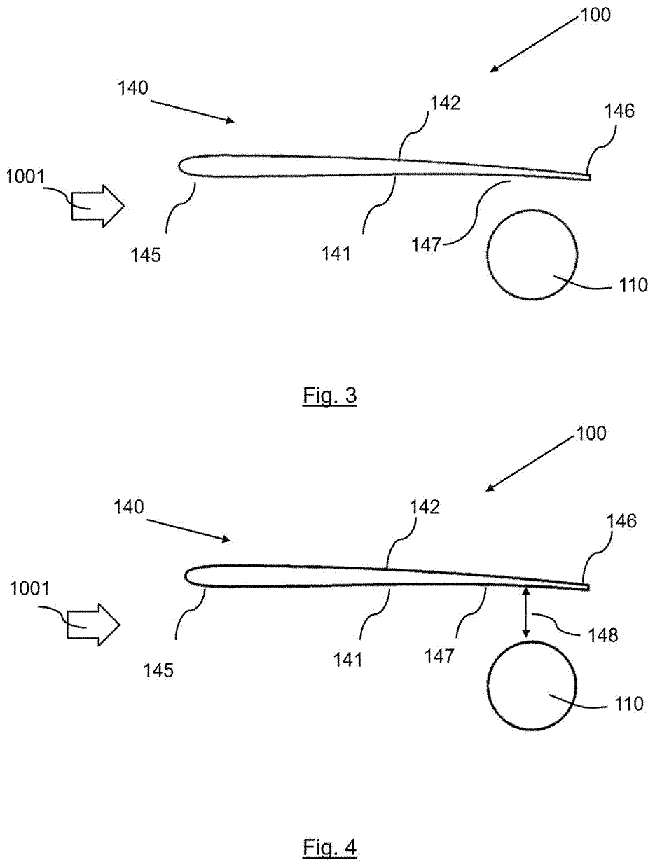

FIG. 3 shows a schematic plan view of a landing gear arrangement 100 according to a second embodiment of the invention. The second embodiment is similar to the first embodiment and only the differences will be described. A side view of the second embodiment is in fact the same as the side view of the first embodiment (i.e., FIG. 1).

Here, an aerofoil shape is still provided in the plan view, but it is a slightly different aerofoil shape. Firstly, the outer side 142 is not planar and instead provides a convex profile. Hence, when the landing gear bay door 140 is closed in use, the convex outer side 142 forms an outside contour of the aircraft. It can also be seen that the rear edge 146 is angled downwards to provide a more concave profile to the inner side 141. In particular, the landing gear leg is located in line (perpendicular to the airflow 1001) with a location near to the maximum concave point 147 of the inner side 141.

FIG. 4 shows a schematic plan view of a landing gear arrangement 100 according to third embodiment of the invention. The third embodiment is similar to the second embodiment and only the differences will be described. A side view of the third embodiment is in fact the same as the side view of the second embodiment (i.e., FIG. 1).

Here, the landing gear leg is offset from the aerofoil door 140 by an offset distance (labelled as 148) of 50 mm.

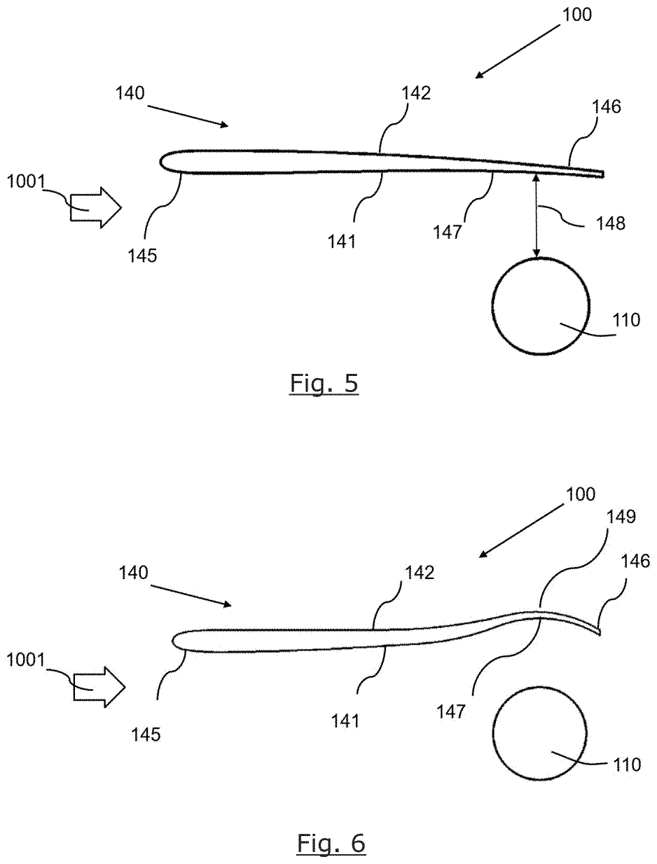

FIG. 5 shows a schematic plan view of a landing gear arrangement according to fourth embodiment of the invention. The fourth embodiment is similar to the third embodiment and only the differences will be described. A side view of the fourth embodiment is in fact the same as the side view of the third embodiment (i.e., FIG. 1).

Here, the landing gear leg is offset from the aerofoil door 140 by an offset distance (labelled as 148) of 100 mm.

FIG. 6 shows a schematic plan view of a landing gear arrangement 100 according to fifth embodiment of the invention. The fifth embodiment is similar to the second embodiment and only the differences will be described. A side view of the fifth embodiment is in fact the same as the side view of the second embodiment (i.e., FIG. 1).

Here, the aerofoil shape includes a “rear bulge” 149 on the upper (outer) side 142. Hence, the outer side 142 of the door has a bulged portion, where the contour is further outwards of the rest of the outer contour of the door. This rear bulge 149 matches and corresponds to the contour of the concave shape of the inner side 141.

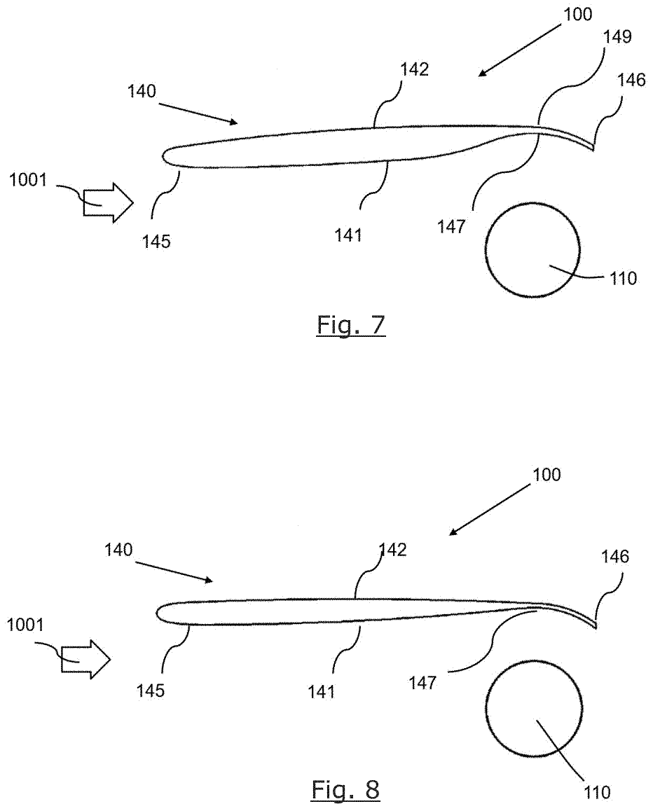

FIG. 7 shows a schematic plan view of a landing gear arrangement 100 according to sixth embodiment of the invention. The sixth embodiment is similar to the fifth embodiment and only the differences will be described. A side view of the sixth embodiment is in fact the same as the side view of the fifth embodiment (i.e., FIG. 1).

Here, the leading region of the outer side 142 is further outwards, corresponding to the level of the rear bulge of the fifth embodiment. This gives a much thicker forward region of the door 140. Hence, the outer side 142 is much more planar compared to that of the fifth embodiment. However, it still enables a concave shape in the inner side 141.

FIG. 8 shows a schematic plan view of a landing gear arrangement according to seventh embodiment of the invention. The seventh embodiment is similar to the sixth embodiment and only the differences will be described. A side view of the seventh embodiment is in fact the same as the side view of the sixth embodiment (i.e., FIG. 1).

Here, the trailing edge 146 is located much further inwards (towards the leg 110). Hence, the concave shape of the inner side 141 can be retained with a substantially planar outer side 142 and with a thinner door 140 thickness.

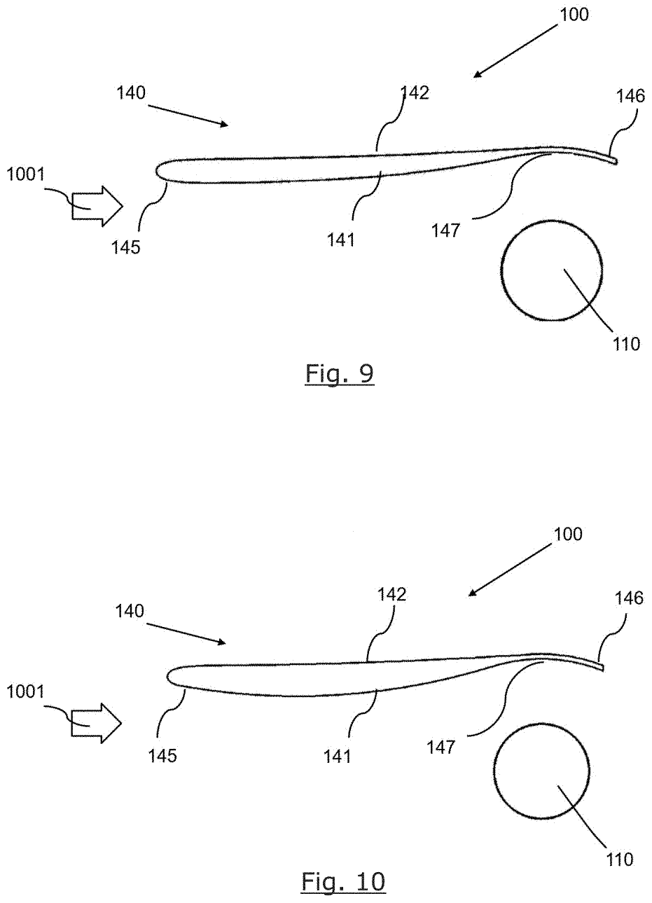

FIG. 9 shows a schematic plan view of a landing gear arrangement according to eight embodiment of the invention. The eighth embodiment is similar to the fifth embodiment and only the differences will be described. A side view of the eighth embodiment is in fact the same as the side view of the fifth embodiment (i.e., FIG. 1).

Here, the bulge 149 is much reduced meaning that the outer side 142 of the door 140 extends less far outwards. Consequently, the concaveness of the inner side 141 is reduced.

FIG. 10 shows a schematic plan view of a landing gear arrangement 100 according to ninth embodiment of the invention. The ninth embodiment is similar to the eighth embodiment and only the differences will be described. A side view of the ninth embodiment is in fact the same as the side view of the eighth embodiment (i.e., FIG. 1).

Here, the forward portion of the inner side 141 extends further inwards and hence increases the thickness of the door 140. This means that for the same outer side 142 contour (i.e., still substantially planar), the concaveness of the inner side 141 is increased.

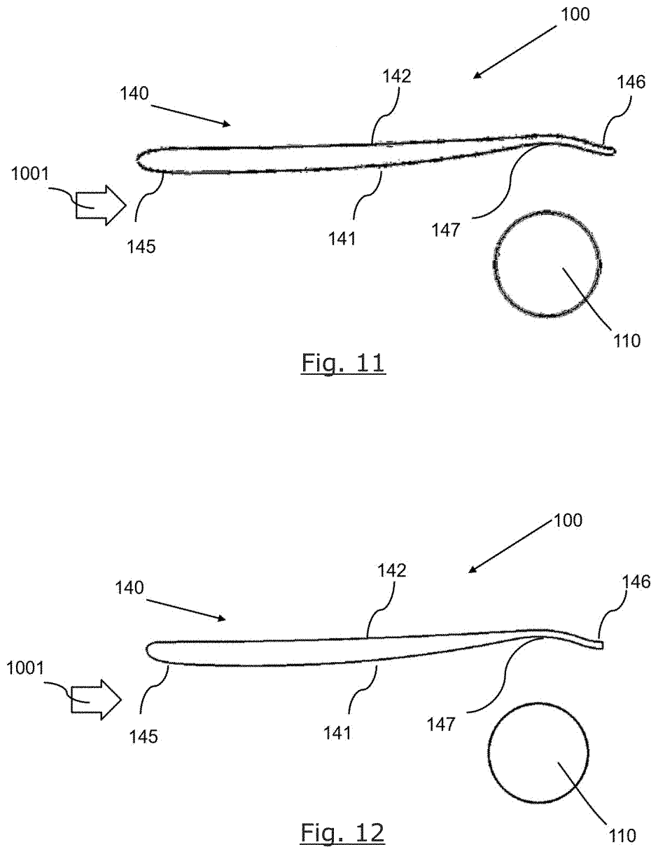

FIG. 11 shows a schematic plan view of a landing gear arrangement according to tenth embodiment of the invention. The tenth embodiment is similar to the eighth embodiment and only the differences will be described. A side view of the tenth embodiment is in fact the same as the side view of the eighth embodiment (i.e., FIG. 1).

Here, the trailing edge 146 takes on a slightly different shape with the tail being inflected so as to not extend inwards as far (if it followed the “bulge” contour). Instead, the trailing edge 146 portion is substantially straight and extends back in line with the airflow 1001.

FIG. 12 shows a schematic plan view of a landing gear arrangement according to eleventh embodiment of the invention. The eleventh embodiment is similar to the tenth embodiment and only the differences will be described. A side view of the eleventh embodiment is in fact the same as the side view of the tenth embodiment (i.e., FIG. 1).

Here, the trailing edge 146 is thicker than in the twelfth embodiment.

FIG. 13 shows a schematic plan view of a landing gear arrangement according to twelfth embodiment of the invention. The twelfth embodiment is similar to the eleventh embodiment and only the differences will be described. A side view of the twelfth embodiment is in fact the same as the side view of the eleventh embodiment (i.e., FIG. 1).

Here, the inner side 141 extends further inwards in front of the bulged portion 149 (giving a thicker leading portion of the door 140).

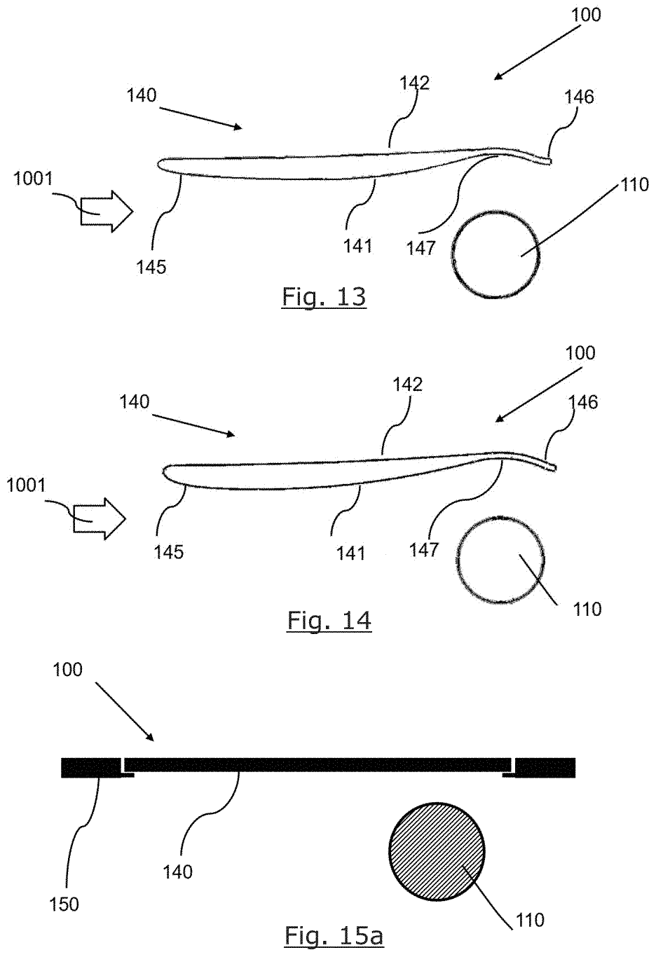

FIG. 14 shows a schematic plan view of a landing gear arrangement according to thirteenth embodiment of the invention. The thirteenth embodiment is similar to the twelfth embodiment and only the differences will be described. A side view of the thirteenth embodiment is in fact the same as the side view of the twelfth embodiment shown in FIG. 1.

Here, the outer side 142 extends further outwards at the bulge 149 so as to reduce the planar-ness of the outer surface whilst still providing a large concaveness of the inner side 141.

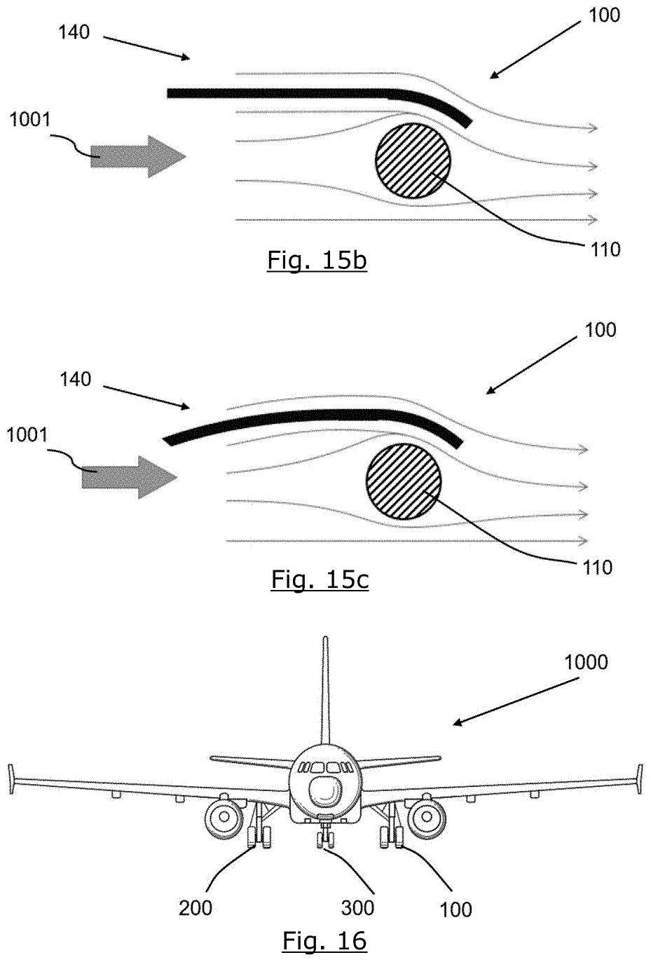

FIG. 15a shows a schematic upside downside view of a stowed and closed landing gear arrangement 100 according to fourteenth embodiment of the invention. In other words, this is a view looking along the leg 110 when the leg is stowed in an aircraft landing gear bay (defined by walls 150 of the aircraft surrounding the bay).

The fourteenth embodiment is similar to the first embodiment in that a shaped door 140 (e.g., any suitable aerofoil shape) is provided. However, the door shape when the door is stowed (as it is in FIG. 15a) is planar (on both sides 141, 142). The door 140 only takes up a curved shape when it is opened away from the walls 150. In other words, the door 140 is biased to take up the curved shape, but is forced to take up the planar shape of FIG. 15a by the walls 150.

This could be achieved by having the door being pre-stressed and/or being made out of a memory shape alloy.

FIG. 15b shows a schematic plan view of the landing gear arrangement 100 of FIG. 15a, in an open and deployed configuration. Here, the door 140 has started to move away from the walls (not shown) and the trailing edge of the door has moved to curve downwards, providing a concave inner side 141 and convex outer side 142.

FIG. 15c shows a schematic plan view of the landing gear arrangement of FIG. 15a, in a second open and deployed configuration. As the door has moved further away from the walls, the leading edge has also curved downwards, providing an even more concave inner side 141 and even more convex outer side 142.

In FIGS. 15b and 15c, the resulting airflow can be seen. Airflow is directed by the trailing edge of the door smoothly behind the landing gear leg 110.

FIG. 16 shows a schematic front view of an aircraft 1000 with a nose landing gear arrangement 300 and two main landing gear arrangements 100, 200, the landing gear arrangements being suitable for being in accordance with any of the embodiments of the invention.

Whilst the present invention has been described and illustrated with reference to particular embodiments, it will be appreciated by those of ordinary skill in the art that the invention lends itself to many different variations not specifically illustrated herein. By way of example only, certain possible variations will now be described.

The landing gear leg may be offset from the aerofoil door by different offset distance, being greater or less than the figures stated herein, and the distance need not be exactly the same for the length of the leg.

The door inner side 141 may not be concavely curved and instead may have any suitable curved profile.

The door outer side 142 may have any suitable profile. The outline of the door may be differently shaped for a different aircraft in view of the shape of the opening of the landing gear bay required to allow the deployment therethrough of the landing gear, which may be differently configured depending on the design of the aircraft concerned. For example, not all landing gear legs are provided with a side stay.

The door rear edge 146 may taper to a point instead of having a straight end.

The door may be made of any suitable material. It may be 3D printed.

The door 140 may be attached directly to an aircraft (not via the leg 110). For example, at the door top edge 143 may be an attachment mechanism to pivotally mount the door 140 to an aircraft, in use.

It will be appreciated that the landing gear leg 110 may have any suitable number of wheels, for example being greater than two.

Where in the foregoing description, integers or elements are mentioned which have known, obvious or foreseeable equivalents, then such equivalents are herein incorporated as if individually set forth.

Reference should be made to the claims for determining the true scope of the present invention, which should be construed so as to encompass any such equivalents. It will also be appreciated by the reader that integers or features of the invention that are described as preferable, advantageous, convenient or the like are optional and do not limit the scope of the independent claims. Moreover, it is to be understood that such optional integers or features, whilst of possible benefit in some embodiments of the invention, may not be desirable, and may therefore be absent, in other embodiments.

It should be noted that throughout this specification, “or” should be interpreted as “and/or”, unless stated otherwise.

Although the invention has been described above mainly in the context of a fixed-wing aircraft application, it may also be advantageously applied to various other applications, including but not limited to applications on vehicles such as helicopters, drones, trains, automobiles and spacecraft.

1. An aircraft landing gear bay door comprising:
an attachment mechanism configured to pivotally mount the aircraft landing gear bay door to an aircraft such that the aircraft landing gear bay door moves between a closed position, in which the aircraft landing gear bay door at least partially closes an aircraft landing gear bay to stow a landing gear therein, and an open position, in which the aircraft landing gear bay door at least partially opens the landing gear bay to allow the landing gear to deploy,
a first side arranged to face inwardly in relation to the aircraft landing gear bay when the aircraft landing gear bay door is closed and face towards one side of a main leg of the landing gear when the aircraft landing gear bay door is open and the landing gear is deployed, and
a second opposite side arrange to face outwardly in relation to the landing gear bay when the aircraft landing gear bay door is closed and thus provide an aerodynamic outer surface of the aircraft, and face away from the main leg of the landing gear when the aircraft landing gear bay door is open and the landing gear is deployed,
wherein the shape formed from the first and second sides provides an aerofoil profile of the aircraft landing gear bay door.

2. The aircraft landing gear bay door as claimed in claim 1, wherein the first side provides one half of an aerofoil profile and wherein the second side provides a corresponding other half of an aerofoil profile.

3. The aircraft landing gear bay door as claimed in claim 2, wherein a leading edge of the aerofoil profile is located at an upstream edge of the aircraft landing gear bay door, when open.

4. The aircraft landing gear bay door as claimed in claim 1, wherein the aerofoil profile has a height corresponding to at least 80% of the height of the aircraft landing gear bay door.

5. The aircraft landing gear bay door as claimed in claim 1, wherein the aerofoil profile has a camber.

6. The aircraft landing gear bay door as claimed in claim 1, wherein the trailing edge of the aerofoil profile is straight.

7. The aircraft landing gear bay door as claimed in claim 1, wherein the trailing edge of the aerofoil profile is tapered.

8. The aircraft landing gear bay door as claimed in claim 1, wherein a region of the aerofoil profile is provided with a bulged portion, bulging towards the second side of the door.

9. The aircraft landing gear bay door as claimed in claim 8, wherein the first side of the aerofoil profile is provided with the bulged portion.

10. The aircraft landing gear bay door as claimed in claim 9, wherein the second side of the aerofoil profile is also provided with the bulged portion.

11. The aircraft landing gear bay door as claimed in claim 1, wherein the shape of the aircraft landing gear bay door is such that along a longitudinal section of the aircraft landing gear bay door when open, the thickness of the aircraft landing gear bay door is greater than a first thickness for at least a fifth of its length in the longitudinal direction and is less than a second thickness for at least a fifth of its length in the longitudinal direction, the first thickness being at least twice as great as the second thickness.

12. The aircraft landing gear bay door as claimed in claim 11, wherein the thickness of the aircraft landing gear bay door is greater than the first thickness for at least half of its length in the longitudinal direction and is less than the second thickness for at least a fifth of its length in the longitudinal direction.

13. The aircraft landing gear bay door as claimed in claim 12, wherein the thickness of the aircraft landing gear bay door is greater than the first thickness for at least three fifths of its length in the longitudinal direction and is less than the second thickness for at least a fifth of its length in the longitudinal direction.

14. The aircraft landing gear bay door as claimed in claim 1, wherein the aircraft landing gear bay door comprises a moveable component, moveable from a first position when the door is closed to a second position when the aircraft landing gear bay door is open and wherein, in the second position, the moveable component moves to form the aerofoil profile.

15. The aircraft landing gear bay door as claimed in claim 14, wherein moveable component is a memory shape component and wherein the memory shape component is biased to be in the second portion and is urged to the first position as the aircraft landing gear bay door closes.

16. An aircraft landing gear arrangement including:
the aircraft landing gear bay door of claim 1, and
a landing gear including a main landing gear leg, the main landing gear leg being pivotally mountable in relation to an aircraft landing gear bay between a stowed and a deployed position, and comprising a number of landing gear wheels arranged to roll in a fore/aft direction when in the deployed position.

17. The aircraft landing gear arrangement according to claim 16, wherein, when the aircraft landing gear bay door is in the open position and the landing gear is in the deployed position, the aerofoil profile is at least partially aligned with the landing gear leg in the fore/aft direction.

18. The aircraft landing gear arrangement according to claim 17, wherein, when the aircraft landing gear bay door is in the open position and the landing gear is in the deployed position, the bulged portion of the aerofoil profile is at least partially aligned with the landing gear leg in the fore/aft direction.

19. The aircraft landing gear arrangement according to claim 16, wherein, when the aircraft landing gear bay door is in the open position and the landing gear is in the deployed position, the aerofoil profile is offset from the landing gear leg in the lateral direction by an offset distance of at least 30 mm.

20. The aircraft comprising the aircraft landing gear bay door of claim 1.

21. A method of operating an aircraft comprising the steps of:
opening a landing gear bay door,
deploying a landing gear, including a main leg, and
an aerofoil profile to the aircraft landing gear bay door configured to reduce a velocity of the air flow in between the side of the main leg of the landing gear and the landing gear bay door.

22. A method of reducing noise generated by a landing gear on landing approach comprising:
opening a landing gear bay door,
deploying a landing gear, including a main leg, and
an aerofoil profile to the aircraft landing gear bay door causing the velocity of the air flow in between the side of the main leg of the landing gear and the landing gear bay door to be reduced.
